(19) United States
(12) Patent Application Publication
(10) Pub. No.: US 2023/0192214 A1
(43) Pub. Date: Jun. 22, 2023

(54) DUAL REARVIEW MIRROR

(71) Applicant: David Kondroski, Mount Pleasant, UT (US)

(72) Inventor: David Kondroski, Mount Pleasant, UT (US)

(21) Appl. No.: 17/553,282

(22) Filed: Dec. 16, 2021

(51) Int. Cl. B62J 29/00

(52) U.S. Cl. CPC B62J 29/00

(57) ABSTRACT

A dual rearview mirror comprising a main mirror and a secondary mirror arranged within a mirror head. The main mirror can be fixedly attached to the mirror head in the lower inboard position. The secondary mirror can be adjustably attached to the mirror head in the upper outboard position so as to provide a user with a rearward view in a standing position. The mirror head can be adjustably attached to a mirror stalk assembly so as to provide a user with a rearward view in a seated position. The mirror stalk assembly can be designed to be stable and eliminate mirror vibrations.

### TECHNICAL FIELD

The present specification relates to a rearview mirror, more specifically it relates to a dual rearview mirror for viewing behind a cyclist while standing and/or sitting.

### BACKGROUND

An adventure or dual-sport motorcycle is a type of street-legal motorcycle that is designed for both on and off-road use. Dual-sport motorcycles are equipped with street-legal equipment such as lights, speedometer, mirrors, horn, license plate mounting, and muffler and can be registered and licensed. Traditional motorcycle mirrors provide only one rearward view, which is normally adjusted by the rider for riding seated. However, a dual-sport rider may spend as much as 50% of their time in a standing riding position, especially when riding off road.

As with regular motorcycles, dual-sport riders typically travel in groups for safety purposes. It is important for group members to stay in relatively close proximity to each other, even when riding single file. This requires the front cyclist to keep an eye on those behind to make sure they don't get too far ahead. In order to see other riders behind them, they have to either sit and look at their mirrors, adjust one mirror for a standing rearward view, or perform a head-check, which can distract them from obstacles on the trail ahead and lead to dangerous situations. Current mirrors on the rider's bike are for when the rider is seated or adjusted to when the rider is standing which restricts the rider's rear view. Currently there is nothing that exist that can be used while the rider is standing or sitting looking through the same mirror system,

It would be advantageous to provide a way to view the road and road conditions with a quick glance into a mirror whether the rider is seated or standing.

### SUMMARY

Aspects disclosed herein comprise a dual rearview mirror system for a vehicle. A dual rearview mirror system for a vehicle can comprise a mirror head coupled to a stalk that can have a base end and a mirror end. A main mirror and a secondary mirror can be coupled to the mirror head wherein the main mirror and the secondary mirror can be independently adjustable wherein the mirror end is adjustably coupled to the mirror head, the base portion is adjustably coupled to a base, and wherein the base is coupled to the vehicle. The mirror head can be adjustably coupled to the stalk. The main mirror is fixed within the mirror head and the secondary mirror can be adjustably coupled to the mirror head.

A dual rearview mirror system can further comprise a base wherein the mirror end is adjustably coupled to the mirror head, the base end is adjustably coupled to the base, and the base may be coupled to the vehicle. The secondary mirror can be in the upper outboard area of the mirror head. The main mirror can be in the lower inboard area of the mirror head. The secondary mirror is in the lower half of the mirror head. The main mirror can be in the upper half of the mirror head. The mirror head can be coupled to the base such that when the base is coupled to the vehicle the secondary mirror allows a user an effective rear view when the user is in a standing position, and wherein the main mirror allows a user an effective rear view when the user is in a seated position. The secondary mirror can be adjustable from at least 10 degrees off the vertical axis of the main mirror. The secondary mirror is adjustable from 10 to 30 degrees off the vertical axis of the main mirror. The mirror head is adjustably coupled to the vehicle with a ball joint. The secondary mirror can be adjustably connected to the mirror head through a ball joint.

A method of assembling a dual rearview mirror, the method comprising the acts of providing a mirror head. The mirror head can be fixedly coupled to a main mirror. The mirror head can be adjustably coupled to a secondary mirror. The mirror stalk can be adjustably attached to the mirror head. The main mirror is coupled mirror head in a lower inboard arrangement and the secondary mirror is coupled to the mirror head in an upper outboard arrangement. The secondary mirror is adjustably attached with a ball socket. The mirror head can be adjustably attached with a ball socket.

A method of assembly a dual rearview mirror comprising providing a mirror head. Fixedly coupling a main mirror to the mirror head in the upper half arrangement. Adjustably coupling a secondary mirror to the mirror head in the lower half arrangement. Adjustably attaching the mirror head to a mirror stalk assembly. The main mirror is coupled mirror head in an upper half arrangement and the secondary mirror is coupled to the mirror head in a lower half arrangement. The secondary mirror is adjustably attached with a ball socket. The mirror head can be adjustably coupled to a ball socket.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for”, and will also recite the word “function” (i.e., will state “means for performing the function of molding a . . . , without also reciting in such phrases any structure, material or act in support of the function. Thus, even when the claims recite a “means for performing the function of molding a . . . , step for performing the function of molding a . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 is a front view of an embodiment of a dual rearview mirror in accordance to one, or more embodiments;

FIG. 2 is a side view of an embodiment of a dual rearview mirror in accordance to one, or more embodiments;

FIG. 3 is a side view of an embodiment of a dual rearview mirror in accordance to one, or more embodiments;

FIG. 4 is a front view of another embodiment of a dual rearview mirror in accordance to one, or more embodiments;

FIG. 5 is a side view of another embodiment of a dual rearview mirror in accordance to one, or more embodiments;

FIG. 6 is a front view of another embodiment of a dual rearview mirror in accordance to one, or more embodiments;

FIG. 7 is a front view of another embodiment of a dual rearview mirror in accordance to one, or more embodiments; and

FIG. 8 is an isometric exploded view of another embodiment of a dual rearview mirror in accordance to one, or more embodiments.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

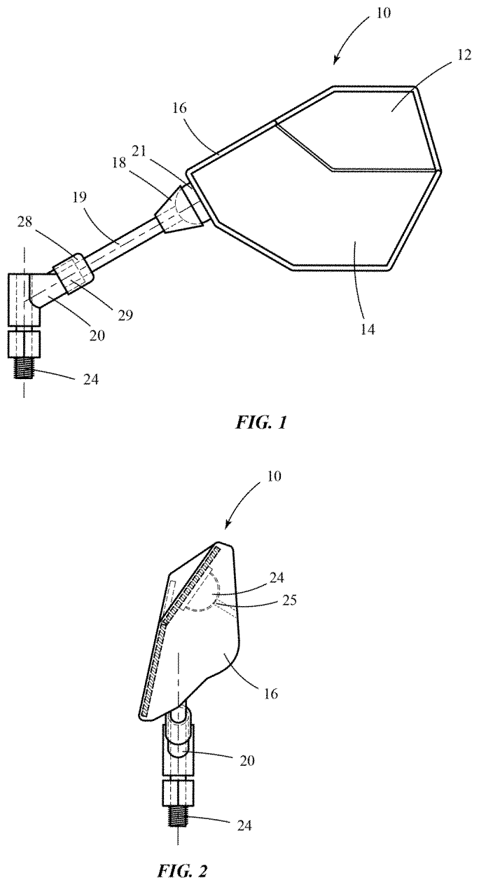

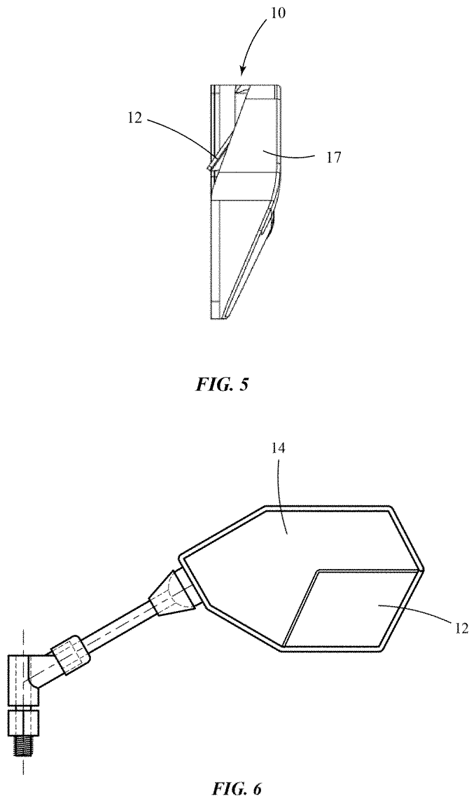

Referring to FIGS. 1-2 a front view of a dual rearview mirror system is shown generally at 10. The dual rearview mirror system 10 can comprise a mirror head 16 wherein the mirror head can comprise a main mirror 14 and a secondary mirror 12. The mirror head 16 can be any general shape, but in the preferred embodiment the mirror head can take on the same outer perimeter shape as the outer edges of the main mirror 14 and the secondary mirror 12. In certain embodiments mirror head 16 can extend beyond main mirror 14 and the secondary mirror 12 wherein the mirror head can protect the main mirror and secondary mirror. The mirror head 16 can have a shape and depth wherein the shape can be any suitable shape, but in the preferred embodiment the shape is aerodynamic wherein the mirror head can be angled out towards a radius substantially near the center of the mirror head on the opposite of the mirrors or it can have a substantially flat portion on its upper backside and a substantially angle on its lower backside. As shown in FIG. 5 the mirror head 16 can have a depth to allow the secondary mirror to move in and out of the mirror head at a set angle. The mirror head 16 can be manufactured from any suitable material, but in the preferred embodiment the material can be, such as, for example, plastics, stainless steel, aluminum, or the like. In other embodiments the whole angle of the mirror head 16 can be moved by the user, or it can be stationary on the mirror end 18.

The mirror head 16 can further comprise a ball socket 25 attached to the inner surface of the mirror head wherein the ball socket can contain a ball 24 that can be attached to the secondary mirror 14 allowing the mirror to rotate within the ball and socket joint. In certain embodiments the secondary mirror can be attached to a mirror mount 102 wherein the mirror mount comprises the ball 24 and the mirror mount can comprise the ball joint which is attached to the ball as shown in FIG. 8. The mirror mount 102 can move the secondary mirror 14 in the ball and joint to the user's desired position as shown in FIG. 8. The secondary mirror 14 is housed in a secondary compartment having a floor 13, at least one side wall, and a back wall wherein the secondary mirror is adjustably coupled to the floor of the secondary compartment.

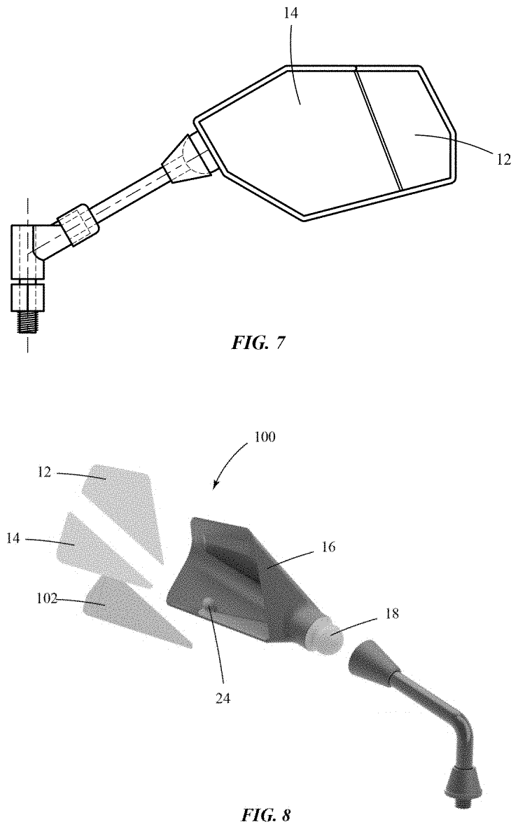

In embodiments, the main mirror 14 can be attached to the mirror head 16 by any appropriate securing means, such as, for example, adhesive, adhesive strips, clamps, clips, rivets, and the like. The main mirror 14 can be in any arrangement that achieves a rearward view from a seated position such as the lower inboard area, or the upper half of the mirror head 16, or in other embodiments the main mirror can be the mirror that the user achieves a rearward view from while standing. In another embodiment the main mirror 14 can be located left of the secondary mirror 12 on the same plane, or the main mirror can be located to the right of the secondary mirror on the same plane as shown in FIG. 6 and FIG. 7. The main mirror 14 and the secondary mirror 12 can be made from such as, for example, glass, plate glass, acrylic, polymir, polycarbonate, silvered or the like with a metal backing for support or coating to prevent fog and distortion.

The dual rearview mirror system 10 can further comprise a stalk 20 wherein the stalk can comprise a mirror end 18 and a base end 28 wherein the mirror end is adjustably or in other embodiments permanently attached to the mirror head 16 and the lower portion is adjustably attached to or permanently attached to a base 20. The base 20 can be attached to the vehicle by any appropriate attachment device, such as, for example, ball and socket joint, pins, hinges, slides, or the like. As shown in FIG. 1 the mirror head 16 can further comprise a second ball 21 protruding from the side of its body or a mirror end 18 that transition into a stalk 19 as shown in FIG. 4. The second ball 21 can be attached to the mirror end 18 wherein the mirror end 18 can have a socket for the ball to attach to allowing the user to adjust the mirror head 16. The mirror head 16 can be adjustably coupled to the stalk 20. The stalk 20 can vary in length to suit the user's needs as shown in FIG. 4. The mirror head 16 can be coupled to the stalk 19 such that when the base end 28 is coupled to the vehicle. The secondary mirror 12 allows a user an effective rear view when the user is in a standing position, and wherein the main mirror 14 allows a user an effective rear view when the user is in a seated position.

The base end 28 can be attached to the base 20 wherein the base end can have a ball or socket joint 29 coupled to the stalk and the base can have the opposing ball or socket that can be attached to the vehicle. In other embodiments the base end 28 can be permanently attached to the base 20. The base 20 can be attached to a vehicle wherein the vehicle can be a cycle's handle bars or bar ends. The base 20 can be attached to a vehicle by any appropriate means, such as, for example, clamp, mirror mount, mirror hanger, screw, bolt, lock nut, adhesive, and/or the like. In some embodiments it is desired to have a stable means of attaching the mirror to the cycle so as to eliminate mirror vibration while riding, such as, for example, YAMAHA™ stalk assembly part no 1RC-26290-01-00, or the like.

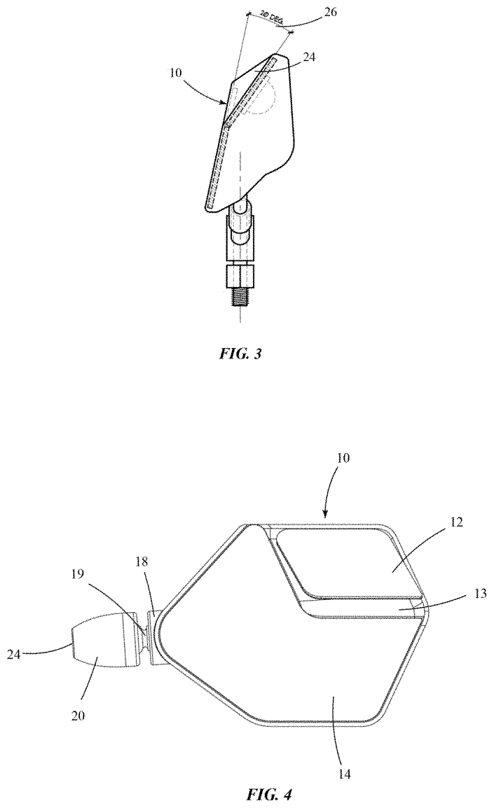

The secondary mirror 12 can be independently adjustably attached to the mirror head 16 by any appropriate means, such as, for example, ball and socket, hinged joint, pivot joint, slides, or the like. The secondary mirror 12 can be adjust vertically by an angle 26, as shown FIG. 3, wherein the angle can be at least 5 degrees to 60 degrees and more preferably the angle can be between 10 degrees to 30 degrees and even still more preferably an angle of 20 degrees off the vertical axis relative to the main mirror 14. The secondary mirror 12 can be in any arrangement that achieves a rearward view from a standing position such as the upper outboard area, or the lower half of the mirror head 16. The secondary mirror 12 can be adjusted such that the secondary mirror is substantially flush with the main mirror 14.

In certain embodiments the secondary mirror 12 can be adjusted by a motor wherein the motor can be attached to the mirror head 16 and the motor can have arms that extend to and attach to the secondary mirror wherein the motor can adjust the mirror up and down, and left and right a pivot joint. In other embodiments the main mirror 14 can be independently adjustable from the secondary mirror 12 wherein both the main mirror and the secondary mirror can adjust separately from each other wherein each mirror has a pivot joint and that can be adjusted by the user.

In certain embodiments the dual rearview mirror could be used in a jeep, ATV, and/or the like, wherein the rearview mirror would be attached to the approximate center and approximate top of the vehicle. The main mirror 14 could be adjusted to view generally behind the vehicle, and the secondary mirror 12 could be adjusted to view the rear tires, or vice versa. This dual view mirror is helpful to a driver as they navigate over and around obstacles.

In embodiments a method of assembling a dual rearview mirror, the method can comprise the acts of providing a mirror head 16 and fixedly coupling a main mirror 14 to the mirror head. A secondary mirror 12 can be adjustably coupling to the mirror head 16, and adjustably attaching the mirror head to a mirror stalk 19. The secondary mirror 12 can be coupled to the mirror head 16 in an upper outboard arrangement. The secondary mirror 12 can be adjustably attached to the mirror head 16 with a ball socket. The mirror head 12 is adjustably attached to the stalk 19 with a ball socket. The main mirror 14 is coupled mirror head in an upper half arrangement and the secondary mirror 12 is coupled to the mirror head 16 in a lower half arrangement. The stalk can be coupled to a vehicle and the main mirror and the secondary mirror can be adjusted to allow a user an effective rear view through the secondary mirror when the user is in a standing position, and to allow an effective rear view when the user is in a seated position through the main mirror. The secondary mirror 12 can smaller than the main mirror and in other embodiments the secondary mirror can be larger than the main mirror. The mirror head 16 substantially encloses all but the reflective surfaces of the main mirror 14 and the secondary mirror 12.

It is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

What is claimed is:

1. A dual rearview mirror system for a vehicle, the system comprising:
a mirror head coupled to a stalk having a base end and a mirror end;
a main mirror and a secondary mirror coupled to the mirror head wherein the secondary mirror is adjustable relative to the main mirror; and
wherein the mirror end is adjustably coupled to the mirror head, and the base portion is coupled to the vehicle.

2. The system of claim 1, wherein:
the mirror head is adjustably coupled to the stalk;
the main mirror is fixed within the mirror head; and
the secondary mirror is adjustably coupled to the mirror head.

3. The system of claim 2, further comprising a base wherein the mirror end is adjustably coupled to the mirror head, the base end is adjustably coupled to the base, and the base is detachably coupled to the vehicle.

4. The mirror of claim 1 wherein the secondary mirror is in the upper outboard area of the mirror head.

5. The mirror of claim 1 wherein the secondary mirror may be adjusted such that the secondary mirror is substantially flush with the main mirror.

6. The mirror of claim 1 wherein the secondary mirror is housed in a secondary compartment having a floor, at least one side wall, and a back wall and wherein the secondary mirror is adjustably coupled to the floor of the secondary compartment.

7. The mirror of claim 1 wherein the mirror head is coupled to the stalk such that when the base end is coupled to the vehicle the secondary mirror allows a user an effective rear view when the user is in a standing position, and wherein the main mirror allows a user an effective rear view when the user is in a seated position.

8. The mirror of claim 1 wherein the secondary mirror is adjustable from at least 10 degrees off the vertical axis of the main mirror.

9. The mirror of claim 8 wherein the secondary mirror is adjustable from 10 to 30 degrees off the vertical axis of the main mirror.

10. The mirror of claim 1 wherein the mirror head is adjustably coupled to the vehicle with a ball joint.

11. The mirror of claim 1 wherein the secondary mirror is adjustably connected to the mirror head through a ball joint.

12. A method of assembling a dual rearview mirror, the method comprising the acts of:
providing a mirror head;
fixedly coupling a main mirror to the mirror head;
adjustably coupling a secondary mirror to the mirror head; and
adjustably attaching the mirror head to a mirror stalk.

13. The method of claim 12 wherein the secondary mirror is coupled to the mirror head in an upper outboard arrangement.

14. The method of claim 12 wherein the secondary mirror is adjustably attached to the mirror head with a ball socket.

15. The method of claim 12 wherein the mirror head is adjustably attached to the stalk with a ball socket.

16. The method of claim 12 wherein the main mirror is coupled mirror head in an upper half arrangement and the secondary mirror is coupled to the mirror head in an a lower half arrangement.

17. The method of claim 12 further comprising coupling the stalk to a vehicle and adjusting the main mirror and the secondary mirror to allow a user an effective rear view through the secondary mirror when the user is in a standing position, and to allow an effective rear view when the user is in a seated position through the main mirror.

18. The mirror of claim 1 wherein the secondary mirror is smaller than the main mirror.

19. The mirror of claim 1 wherein the mirror head substantially encloses all but the reflective surfaces of the main mirror and the secondary mirror.
